(19) United States
(12) Patent Application Publication
(10) Pub. No.: US 2026/0073217 A1
(43) Pub. Date: Mar. 12, 2026

(54) Pruning of Neural Network with Corrective Identification of Redundancy

(71) Applicant: Microsoft Technology Licensing, LLC, Redmond, WA (US)

(72) Inventors: Tianyi CHEN, Kenmore, WA (US); Tianyu DING, Redmond, WA (US); Yong MA, Katy, TX (US); Ilya Dmitriyevich ZHARKOV, Niwot, CO (US); Luming LIANG, Redmond, WA (US)

(73) Assignee: Microsoft Technology Licensing, LLC, Redmond, WA (US)

(21) Appl. No.: 18/828,038

(22) Filed: Sep. 9, 2024

(51) Int. Cl. G06N 3/082; G06N 3/0495

(52) U.S. Cl. CPC G06N 3/082; G06N 3/0495

(57) ABSTRACT

A technique prunes an original neural network over plural pruning periods to reduce a number of groups of trainable parameters in the original neural network by a target number (K) of groups. The technique leverages saliency analysis to identify redundant groups and to-be-retained (important) groups. The pruning is performed by successively projecting the redundant groups to an origin point and successively transferring information contained in the redundant groups to the to-be-retained groups. In some implementations, the pruning also identifies a final set of redundant groups based on plural assessments of saliency of candidate redundant groups, as the candidate redundant groups are projected to the origin point. This aspect operates as a safeguard, reducing the risk that the pruning will degrade the performance of the neural network by erroneously removing non-redundant structure of the original neural network.

### BACKGROUND

An increasing number of applications, devices, and systems incorporate the use of neural networks. Yet many neural networks include a relatively large number of trainable parameters (e.g., filter weights and biases). This factor limits the devices on which large neural networks are capable of being feasibly stored and run. For instance, a user device may lack a sufficient amount of memory to store and run a large neural network.

The industry has proposed several techniques for reducing the sizes of neural networks, pruning being one such technique. Pruning involves identifying and removing trainable parameters in a large neural network that are assessed as redundant, meaning that their omission will not significantly degrade the critical functions performed by the neural network

### SUMMARY

Some existing pruning techniques are labor intensive to configure and run. For instance, some existing pruning techniques require the assistance of an expert to set up hyper-parameters that will control the pruning. This factor limits the utility, scalability, and user-friendliness of these techniques. Further, some existing pruning techniques are capable of degrading the performance of a neural network by erroneously identifying non-redundant structure in a neural network as redundant. This factor compromises the reliability of these pruning techniques. In some cases, this kind of failure renders a neural network inoperable for its intended use.

To address at least some of these problems, a technique is described herein for performing pruning on an original neural network in a controlled, user-friendly, and reliable manner. The pruned neural network has a reduced size compared to the original neural network. This broadens the range of devices on which the pruned neural network is capable of being stored and run.

In some implementations, the technique involves pruning the original neural network over plural pruning periods to reduce a number of the groups of trainable parameters in an original neural network by a target number (K) of groups. The pruning leverages saliency analysis to identify redundant groups and to-be-retained groups (also referred to herein as important groups). The redundant groups are groups in the original set of groups that are to be removed in a final neural network, while the to-be-retained groups are groups that are to be retained in the final neural network. The pruning is performed by successively projecting the redundant groups to an origin point (e.g., zero) and successively transferring information contained in the redundant groups to the to-be-retained groups. This aspect of the technique controls the pruning in a structured, iterative, and reliable manner, which reduces the need for ad hoc configuration of hyper-parameters by an expert. The technique can also be successfully applied to many different types of neural networks, which promotes the scalability of the technique.

In some implementations, the pruning is preceded by preparatory training in which the original neural network is trained without pruning. In some implementations, the pruning is followed by post-pruning training in which the to-be-retained groups are trained without performing pruning.

In some implementations, the pruning identifies a final set of redundant groups based on plural assessments of saliency of candidate redundant groups, as the candidate redundant groups are projected to the origin point. This aspect of the technique operates as a safeguard, reducing the risk that the pruning will degrade the performance of the neural network due to the erroneous removal of non-redundant structure of the original neural network.

The above-summarized technique is capable of being manifested in various types of systems, devices, components, methods, computer-readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

FIG. 1 shows a computing system for pruning an original neural network in a controlled manner.

FIG. 2 shows a process performed by the system of FIG. 1 for producing an original set of groups of trainable parameters.

FIG. 3 shows an example of how the process of FIG. 2 groups the nodes of an original neural network.

FIG. 4 shows an example of how the process of FIG. 2 forms groups of trainable parameters that are associated with respective nodes groups.

FIG. 5 shows an overview of a pruning component, which is part of the computing system of FIG. 1. This implementation of the pruning component omits the kind of safeguards that are described with reference to FIG. 10 to reduce the risk of erroneous removal of important structure from an original neural network.

FIG. 6 shows an overview of the operation of the pruning component of FIG. 5.

FIG. 7 shows a process that provides a more specific description of the operation of the pruning component of FIG. 5.

FIG. 8 is a graphical illustration of how the process of FIG. 7 updates a trainable parameter of a redundant group.

FIG. 9 is a graphical illustration of how the process of FIG. 7 successively updates a trainable parameter of an important group.

FIG. 10 is an overview of a redundancy-checking component, which is part of another implementation of the pruning component of FIG. 1.

FIG. 11 shows a process that provides a description of the operation of the redundancy-checking component of FIG. 10.

FIG. 12 shows a process that describes a version of the operation of the pruning component of FIG. 1 that uses the redundancy-checking component of FIG. 10.

FIG. 13 describes the results of applying the computing system of FIG. 1 to the task of pruning a language model, relative to baseline results.

FIG. 14 describes results of applying the computing system of FIG. 1 to an object detection model, relative to baseline results.

FIGS. 15-17 are flowcharts that show three aspects of the operation of the computing system of FIG. 1.

FIG. 18 shows computing equipment that, in some implementations, is used to implement the computing system of FIG. 1.

FIG. 19 shows an illustrative type of computing system that, in some implementations, is used to implement any aspect of the features shown in the foregoing drawings.

The same numbers are used throughout the disclosure and figures to reference like components and features.

### DETAILED DESCRIPTION

### A. Overview

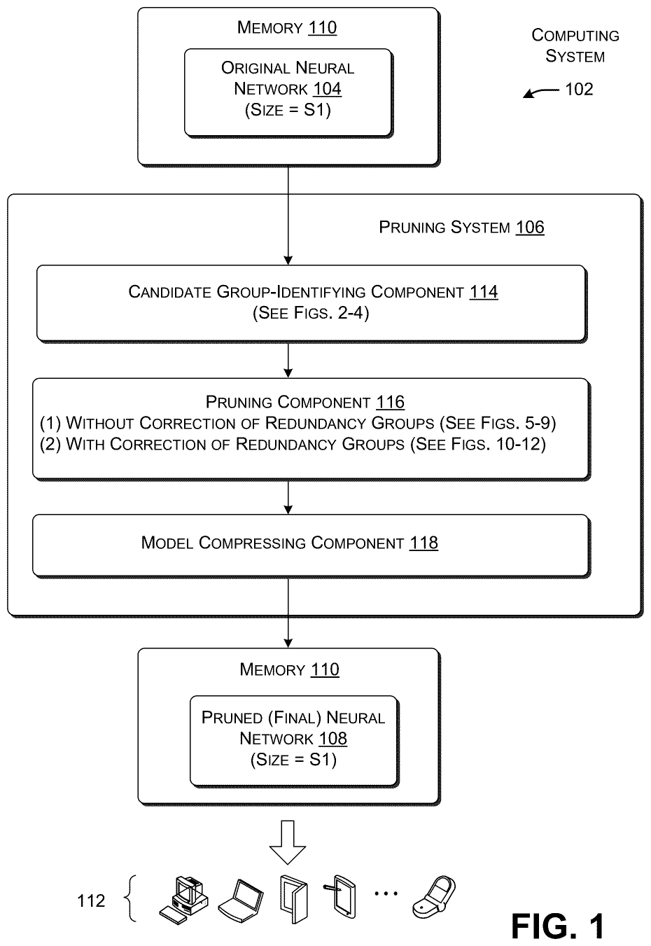

FIG. 1 shows a computing system 102 for operating on an original neural network 104 having plural layers. The computing system 102 is capable of operating on original neural networks with weights that have been subject to any amount of pretraining, including no pretraining. A pruning system 106 performs structural pruning on the original neural network 104, to produce a final neural network 108. Structural pruning is pruning that identifies structures of the original neural network 104 that are capable of being removed without adversely affecting the functions performed by the original neural network 104. These structures are then removed, e.g., by removing the trainable parameters associated with these structures. Trainable parameters, for instance, include weights and biases associated with individual components of the original neural network 104. More specifically, for at least some cases, a parameter is a variable that, at any given time, has a specific value. Reference to a “parameter” herein is shorthand reference to a “parameter value,” unless the text otherwise clarifies. For instance, when it is appropriate to emphasize the variable associated with a parameter in a more general way, the explanation will refer to a parameter variable or the like.

The original neural network 104 has a first size and the final neural network 108 has a second size that is less than the first size. Accordingly, the final neural network 108 consumes less memory 110 than the original neural network 104. Further, the execution of the final neural network 108 involves fewer operations compared to the original neural network 104. These factors expand the type of devices 112 that are capable of feasibly implementing the final neural network 108. For instance, a user device having relatively modest memory and processing resources is capable of running the final neural network 108.

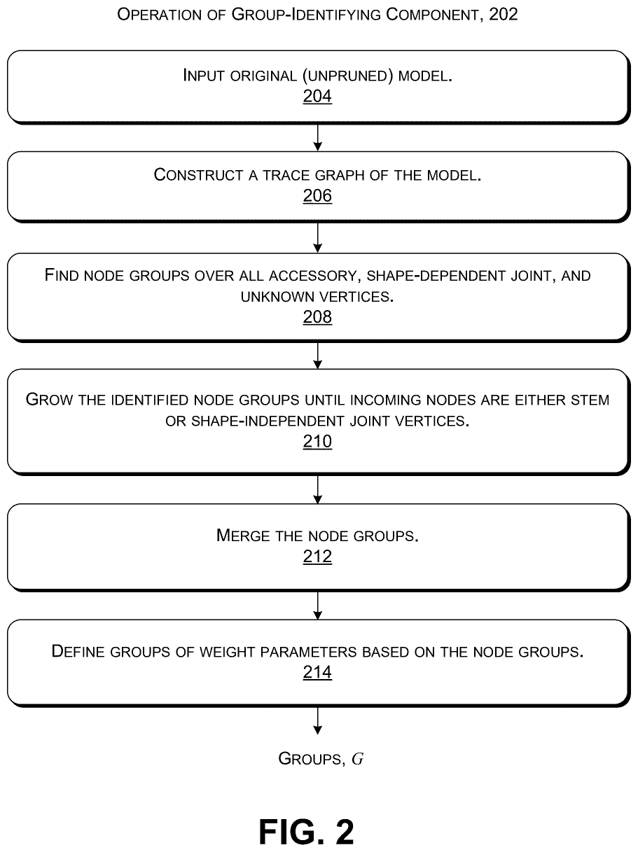

In some implementations, the pruning system 106 includes a candidate group-identifying component 114 for identifying G groups of trainable parameters that are candidates for removal. Each such group is associated with a part of the structure of the original neural network 104. Additional information regarding one implementation of the candidate group-identifying component 114 is set forth below in the context of the explanation of FIGS. 2-4.

A pruning component 116 performs pruning of the original neural network 104 by identifying K groups of trainable parameters that are removable. More formally stated, the purpose of the pruning component 116 is to minimize an objective function ƒ(x), subject to the constraint that the number of groups of trainable parameters is reduced by a target number K. The objective function defines the objective of a training process. One such objective function expresses the difference between actual results produced by a neural network (in its forward pass) and expected results (given by ground-truth labels), e.g., as formulated using cross entropy or any other expression. Redundant groups G_{R} refer to groups that are removable without negatively affecting the performance of the final neural network 108 (compared to the original neural network 104). The remainder of the total number of groups G is referred to as to-be-retained groups G_{I}, or more simply, important groups. In some cases, these groups are associated with structure of the original neural network 104 that cannot be safely removed without negatively affecting the performance of the final neural network 108 (compared to the original neural network 104).

As will be described below, the pruning component 116 performs its pruning over a series of P pruning periods. Pruning involves successively projecting the trainable parameters of the redundant groups towards an origin point (e.g., zero or any other reference point). Pruning also involves successively transferring any information expressed by the redundant groups to the important groups. This transfer is performed by training the important groups, which is interleaved with the successive projection of the redundant groups towards the origin point. That is, the training ensures that the parameters are updated such that the objective function continues to be satisfied, which has the indirect effect of transferring knowledge that was previously contained in the redundant groups to the important groups.

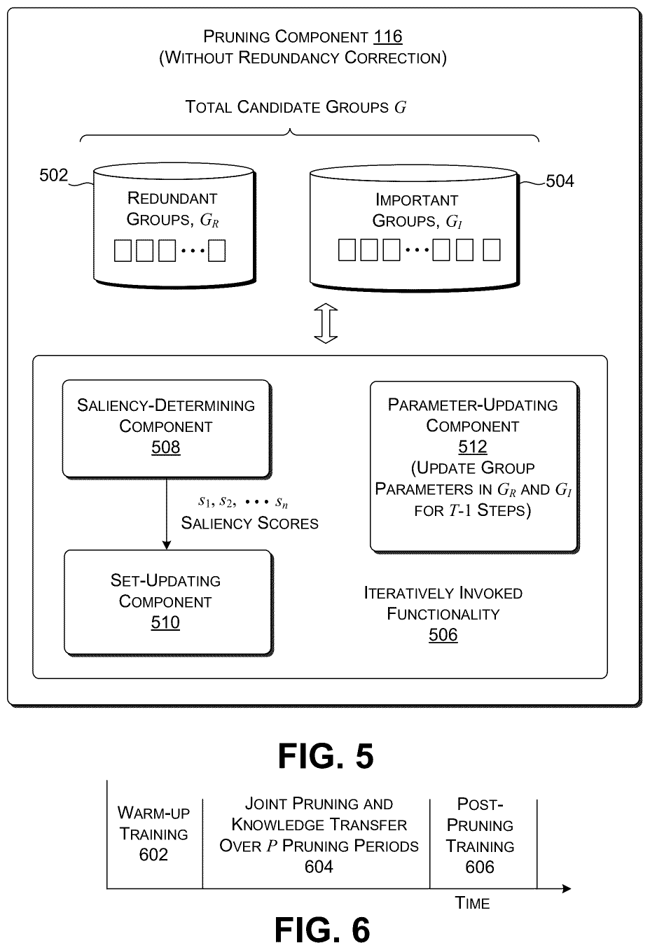

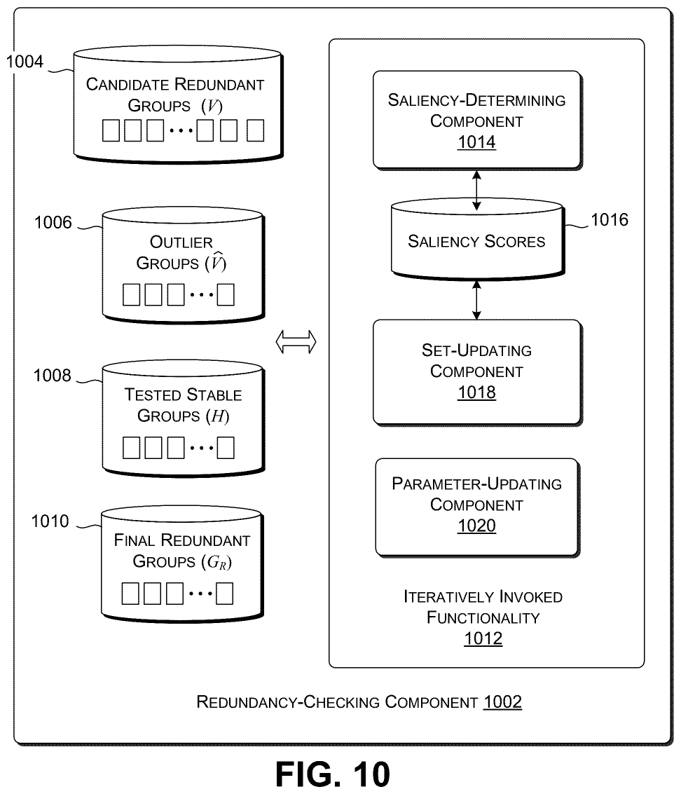

Two variants of the pruning component 116 are described below. A first implementation omits dedicated safeguards that reduce the risk of erroneously removing an important group, that is, by mistakenly interpreting the important group as a redundant group. This implementation is described with reference to FIGS. 5-9. A second implementation, described with reference to FIGS. 10-12, includes such safeguards. The safeguards involve determining the saliency of each candidate redundant group plural times as the candidate redundant group is projected to the origin point. The pruning component 116 is capable of making a more reliable assessment of whether the candidate redundant group is truly a removable structure based on a comprehensive analysis of the trajectory of saliency scores associated with the candidate redundant group, over the course of the projection of the candidate redundant group to the origin point.

A model compressing component 118 formally removes the groups of parameters that are identified as redundant. Removal involves actually eliminating the parameters of the redundant groups or zeroing the parameters out for the removed structures.

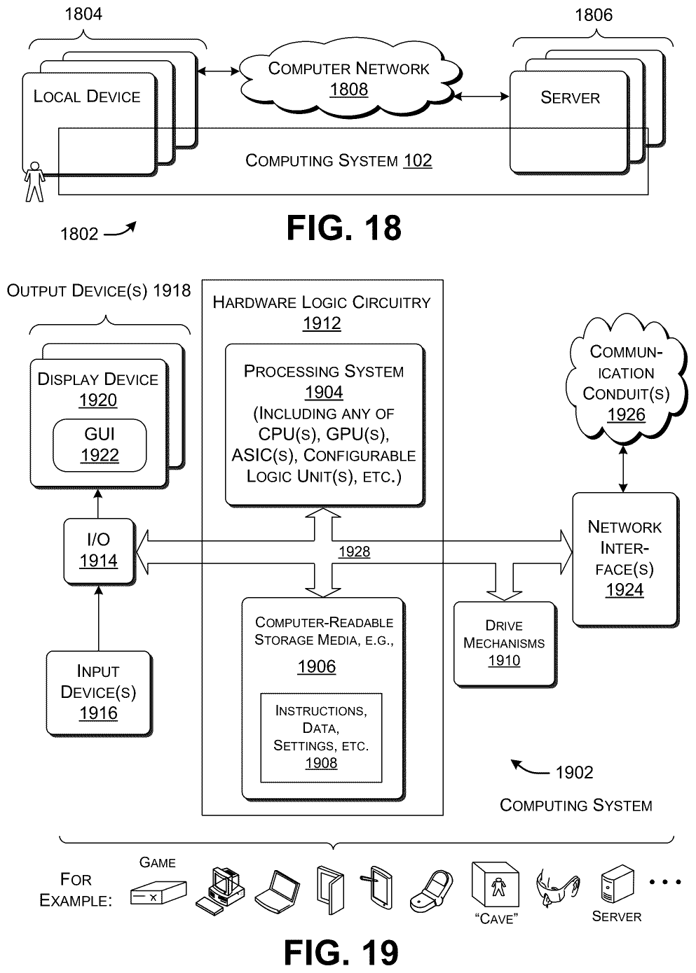

The following terminology is relevant to some examples presented below in the remaining sections. A “machine-trained model” or “model” refers to computer-implemented logic for executing a task using machine-trained parameters that are produced in a training operation. A neural network is an example of a model. A trainable parameter refers to any type of value that can be changed to iteratively adjust the performance of the model. In some contexts, terms such as “component,” “module,” “engine,” and “tool” refer to parts of computer-based technology that perform respective functions. FIGS. 18 and 19, described below, provide examples of illustrative computing equipment for performing these functions.

### B. Identifying Candidate Groups

FIG. 2 shows a process 202 performed by the candidate group-identifying component 114, the purpose of which is to identify groups of weight parameters, often abbreviated as just “weight groups” or “groups” in the explanation below. This process 202 is illustrative; in other implementations, the pruning system 106 receives an identification of candidate groups produced by other algorithms. Alternatively, or in addition, a developer may manually specify the candidate groups. More generally, already-identified groups can be identified from any source(s), and a developer who seeks to prune an original neural network can omit the operations shown in FIG. 2.

The particular process 202 of FIG. 2 identifies zero-invariant structures in the original neural network 104. A zero-invariant structure is a structure that produces zero outputs to a following layer upon setting the trainable parameters of the structure to zero. Further, minimal zero-invariant structures are chosen, meaning that each such structure cannot be further decomposed into additional structures that satisfy the above constraint.

In block 204, the candidate group-identifying component 114 receives an original trained neural network, referred to in FIG. 2 as an original unpruned model. In block 206, the candidate group-identifying component 114 constructs a trace graph (E, V) of the model. A trace graph includes vertices V that represent respective components in the model and edges E that represent connections among the components. In some implementations, the vertices include stem vertices, accessory vertices, and unknown vertices. Stem vertices include trainable parameters that transform input tensors into output information having various shapes. Examples of stem vertices—which typically include most of the vertices in the trace graph—include convolutional layers and linear layers of the original model. Joint vertices establish the connections among different vertices. For instance, joint vertices perform the function of aggregating plural input tensors into a single instance of output information. Examples of joint vertices include add, multiply, and concatenation layers of the original model. Accessory vertices transform a single input tensor into a single instance of output information. Examples of accessory vertices include batch normalization layers and ReLU activation layers of the original model. Unknown vertices (the purpose of which is not recognized by the process 202 in advance) perform other functions in the original model than those specified above.

A joint vertex is said to be shape dependent (SD) if the vertex requires that its inputs have the same shape. Otherwise, the joint vertex is said to be shape-independent (SID). An example of a shape-dependent joint vertex is an add layer. An example of a shape-independent joint vertex is a convolutional layer.

In block 208, the candidate group-identifying component 114 identifies adjacent accessory vertices, SD joint vertices, and unknown vertices in the model. This operation yields an initial set of components, which serve as skeletons for subsequent expansion.

In block 210, the candidate-group identifying component 114 grows the initial set of components into connected structures until all of the incoming vertices (which are vertices into the structures) are either stem or SID joint vertices. In block 212, the candidate group-identifying component 114 merges the components of each expanded structure produced in block 210, to form respective node groups. In block 214, the candidate-group-identifying component 114 partitions the trainable parameters of the original model into groups, as guided by the node groups specified in block 212.

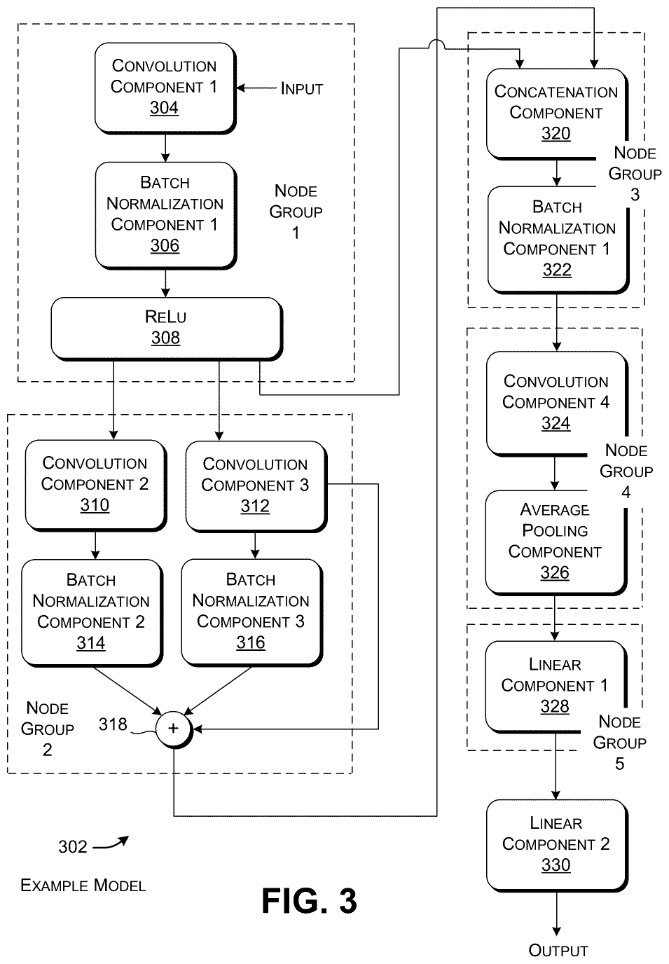

FIG. 3 shows an example of the operation of blocks 206-212 of FIG. 2, performed with respect to an original model 302. The original model 302 is a multilevel neural network having various components 304-330, including convolutional components (304, 310, 312, and 324), batch normalization components (306, 314, 316, 322), linear components (328, 330), an ReLU (rectifier linear unit) component 308, a summation component 318, an average pooling component 326, and a concatenation component 320. The summation component 318 receives inputs from the batch normalization component 314, the batch normalization component 316, and the convolutional component 312. The concatenation component 320 receives inputs from the ReLU component 308 and the summation component 318.

In block 208, the candidate group-identifying component 114 identifies accessory vertices, shape-dependent joint vertices, and unknown vertices, which serve as the skeletons for forming node groups. In the context of FIG. 3, these vertices include the batch normalization components (306, 314, 316, 322), the ReLU component 308, the summation component 318, and the average pooling component 326. In blocks 210 and 212, the candidate group-identifying component 114 expands and merges these seed components into nodes groups 1-5. For instance, the candidate group-identifying component 114 establishes that the stem vertex associated with convolutional component 304 is affiliated with the accessory vertex for the batch normalization component 306 and the ReLU component 308. It also establishes that the stem vertices associated with the convolutional components (310, 312) are affiliated with the accessory vertices for the batch normalization components (314, 316).

The linear component 330 delivers the final output of the model 302. It has a fixed output which is not affiliated with any node group. Further, although not the case for the model 302 of FIG. 3, the candidate group-identifying component 114 does not integrate any an unknown vertex into any node group for reasons of safety.

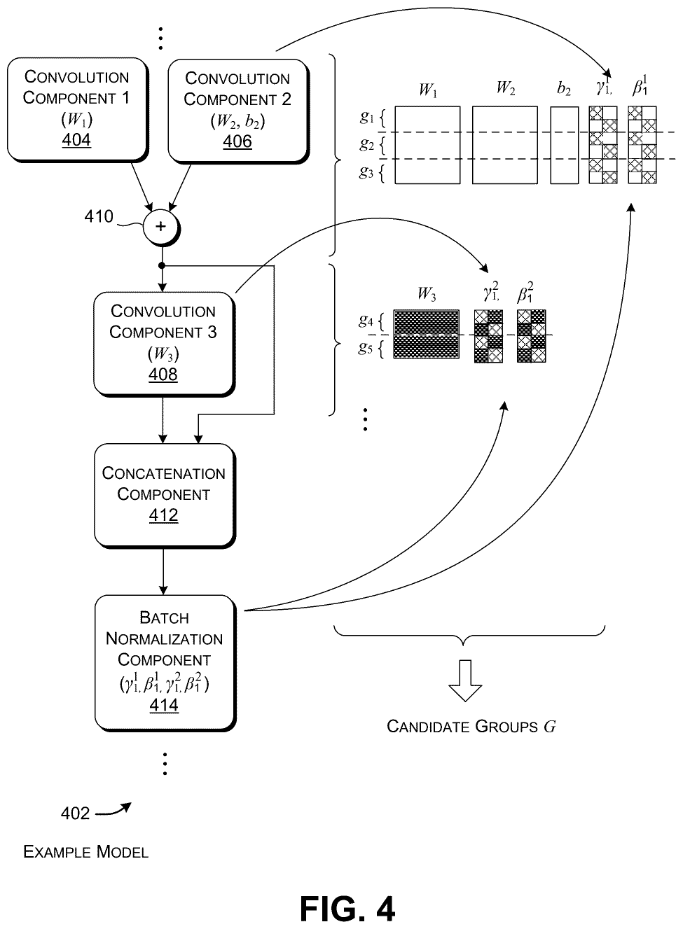

FIG. 4 shows an example of the operation of block 214 of FIG. 2, with respect to a component model 402 having convolutional components (404, 406, 408), a summation component 410, a concatenation component 412, and a batch normalization component 414. Assume that the convolutional components (404, 406) and the summation component 410 form a first node group, the convolutional component 408 forms a second node group, and the concatenation component 412 and the batch normalization component 414 has an affiliation with both the first and second node groups. In block 214, the candidate group-identifying component 114 identifies three parameter groups (g₁-g₃) based on the filter parameters (W₁, W₂) and the bias parameters (b₂) used by the convolutional components (404, 406). For example, group g₁ includes, in part, a first row of filter parameters used by the convolutional components (404, 406). The candidate group-identifying component 114 identifies two parameter groups (g₄ and g4) based on filter parameters (W₃) used by the convolutional component 408. The parameters (γ, β) attributed to the batch normalization component 414 are shown having a checkerboard pattern, which indicates that the batch normalization component 414 has parameters that attend to plural input sources. For instance, the batch normalization component 414 includes some weights and bias parameters (γ₁¹, β₁¹) that attend to the convolutional components (404, 406) of groups g₁-g₃, and some weights and bias parameters (γ₁², β₁²) that attend to the convolutional component 408 of groups g₄ and g₅.

### C. Pruning without Correction of Redundant Groups

FIG. 5 shows an overview of the pruning component 116 for an implementation that does not explicitly safeguard against the erroneous removal of redundant groups. The pruning component 116 includes a data store 502 that stores the identities of the redundant groups G_{R} at each iteration of pruning. The pruning component 116 includes a data store 504 that stores the identities of the important groups G_{I}, which need not be separate from the data store 502. The pruning component 116 records these entries in any manner, e.g., by providing classification information in a master index of groups G. This information identifies the affiliation of each group g, e.g., by indicating whether it is currently classified as a redundant group or an important group.

Functionality 506 interacts with the data stores (502, 504) in an iterative manner. The functionality 506 includes a saliency-determining component 508 for determining the saliency of each candidate group. Saliency expresses the suitability of the candidate group for removal. More specifically, saliency estimates the impact that the removal of a group of parameters will have on the functions performed by the original neural network. Candidates that do not contribute in a significant way to the results provided by the original neural network are suitable for removal.

The saliency-determining component 508 uses one or more metrics to assess suitability for each candidate group. The saliency-determining component 508 can form a single saliency score sg for a group g that is some combination of the group's component saliency scores, such as an average, a consensus, or a weighted consensus of the component saliency scores.

Magnitude. One saliency metric is the magnitude of trainable parameters in a group under consideration. The saliency-determining component 508 determines this metric by aggregating the magnitudes of the group in any manner. For instance, the saliency-determining component 508 generates the L2 norm ∥[x]g∥₂ of individual magnitudes in the group, wherein [x] generally denotes each parameter in a set, and [x], denotes each trainable parameter in a group g. ∥⋅∥₂ represents the L2 norm. The saliency-determining component 508 may optionally normalize the L2 norm based on a consideration of the L2 norms of all of the other groups. Heuristically, a low-magnitude group—and particularly a group with many parameters close to zero—is a more suitable candidate for removal than a higher-magnitude group. This is because a low-magnitude group contributes less to the output of a model compared to the higher-magnitude group.

Average magnitude. Another saliency metric is average magnitude, which measures the average magnitude within the group g. The saliency-determining component 508 may optionally normalize this metric with respect to the average magnitudes of other groups. Groups with low average magnitudes are more suitable candidates for removal compared to groups with higher average magnitudes for the same reason specified above. This metric is useful to prevent the size of a group from biasing the assessment of its saliency.

Cosine Similarity. Another saliency metric is the cosine similarity between the candidate group and the gradient direction of the objective function ƒ(x), expressed as

$${[ x ]}_{g}^{T} [ ∇ {f ( x )}_{g} ] / ( ‖ {[ x ]}_{g} ‖ ‖ [ ∇ {f ( x )}_{g} ‖ ) ,$$

where T denotes transposition, ∥| represents the vector norm, and ∇ is the gradient. A candidate group is a good candidate for removal when its cosine similarity score indicates that the projection of its parameters toward zero aligns with the descent direction of the objective function. This is because such a group is unlikely to significantly contribute to improving the model's performance during training, e.g., because it will not significantly decrease an objective function value.

Taylor Series. Another metric relies on the Taylor expansion to approximate the effects on the objective function of projecting a parameter group to zero. Various orders of the Taylor expansion are particularly useful in estimating the effects of small changes in the parameters on the objective function value. The first-order Taylor expansion is expressible as the dot product of the gradient of the objective function and the change in parameters

$$( \vert {{[ x ]}_{g}^{T} [ ∇ f ( x ) ]}_{g} \vert ) ,$$

which provides a linear approximation of the objective function around a current parameter point. The second-order Taylor expansion captures the curvature of the objective function using the second derivative of the objective function

$$( {{[ x ]}_{g}^{T} [ ∇ f ( x ) ]}_{g} + {{{\frac{1}{2} [ x ]}_{g}^{T} [ {∇}^{2} f ( x ) ]}_{g} [ x ]}_{g} ) ,$$

and may be expressed using the Hessian matrix. A parameter group is a good candidate for removal if one or more of the Taylor series metrics indicates that the impact of setting the parameter group to zero is negligible.

The above saliency measures are set forth by way of illustration, not limitation. Other implementations use one or more other metrics to assess the importance of each parameter group and/or omit one or more of the metrics described above.

A set-updating component 510 relies on the saliency scores computed by the saliency-determining component 508 to determine the classification of candidate groups as either redundant or important. For example, the set-updating component 510 treats the candidate groups with the K lowest saliency scores as redundant, and the remainder as important. The set-updating component 510 updates this assessment over the course of the pruning operation.

A parameter-updating component 512 updates the parameters the groups. In one implementation, for instance, the parameter-updating component 512 updates a parameter x from iteration t to iteration t+1 using \hat{x}ₜ←xₜ−αₜ∇ƒ(xₜ), where a is a learning rate parameter. That is, the current weight parameter xₜ at the current step is combined with the gradient of the objective function ƒ (modified by a learning parameter α), to produce the parameter value xₜ₊₁ at the next step. Although not explicitly specified in the examples below, such an updating step follows a forward pass in which the neural network processes one or more training examples, to produce model-generated results. The objective function expresses the difference (loss) between the model-generated results and ground-truth results. The gradient of the objective function expresses the change of the function at a particular time t, with respect to each particular trainable parameter x. Different implementations can compute error information based on any quantity of training examples (a single example, a batch of examples, all examples, etc.).

FIG. 6 provides an overview of different stages in a pruning operation performed by the pruning component 116. In a warm-up stage 602, the pruning component 116 trains a specified neural network without performing any pruning. This conditions and readies the neural network for pruning. The warm-up stage 602 performs training using Stochastic Gradient Descent (SGD) or some variant thereof (e.g., the ADAM technique set forth in Kingma, et al., “Adam: A Method for Stochastic Optimization,” arXiv, arXiv:1412.6980v9 [cs.LG], Jan. 30, 2017, 15 pages).

In a pruning stage 604, the pruning component 116 iteratively performs pruning over P pruning periods. As will be described below, pruning includes identifying redundant groups and projecting these groups toward the origin point (e.g., zero) over plural steps. Pruning also transfers knowledge contained in the redundant groups to the important groups over plural steps. This is performed by further training the important groups to ensure that the retained parameters continue to satisfy the objective function. In a post-pruning stage 606, the pruning component 116 performs further training on the retained important groups without also performing pruning. The post-pruning stage 606 can use Stochastic Gradient Descent to perform training or any other technique. Other implementations vary the above-described stages in any manner, e.g., by omitting the warm-up stage 602 and/or the post-pruning stage 606, and/or by introducing additional stages not shown in FIG. 6.

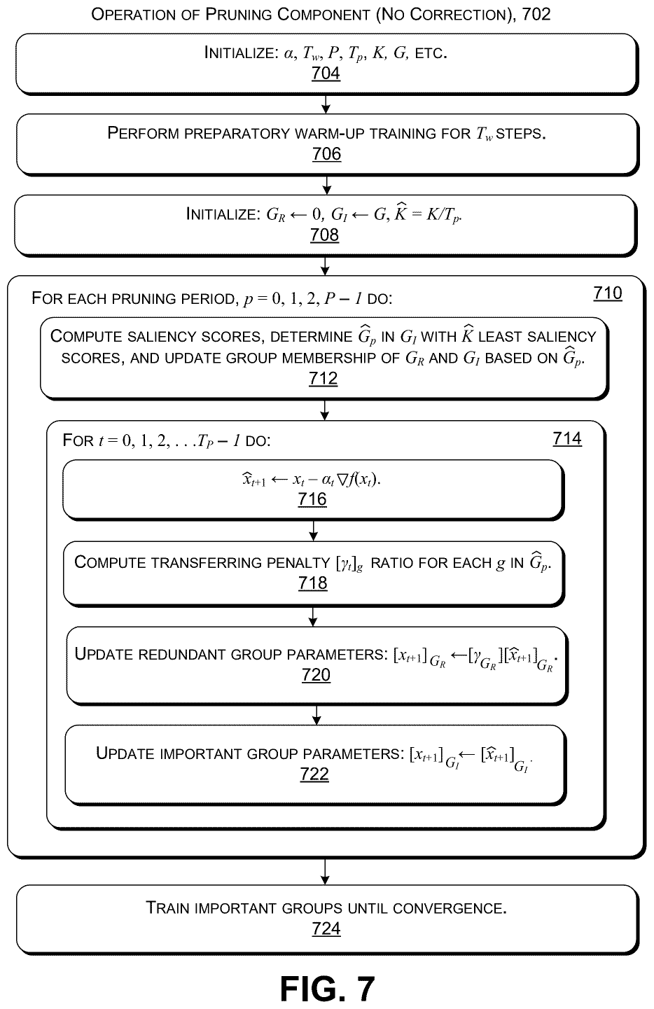

FIG. 7 is a process 702 that describes the operation of one implementation of the pruning component 116. In block 704, the pruning component 116 sets up various control parameters, such as a learning rate (α), a number of steps in the warm-up stage 602 (T_{W}), a number of pruning periods (P), a length of each pruning period (Tₚ), a sparsity level (K), and a total number of groups (G) identified by the candidate group-identifying component 114. In block 706, the pruning component 116 performs pre-training for T_{W} steps. In block 708, the pruning component 116 initializes the redundant set of groups G_{R} to zero members, and initializes the important set of groups G_{I} to all of the candidate groups G.

In block 710, the pruning component 116 performs pruning over P periods. In each pruning period, the pruning component identifies \hat{K} groups for removal. \hat{K} refers to a subset of the total number of redundant groups that will be identified over all of the pruning periods (e.g., \hat{K}=K/T_{R}).

In block 712 (of block 710), the pruning component 116 determines a subset of redundant groups (Ĝₚ) having the \hat{K} lowest saliency scores. The pruning component 116 also updates the membership of the redundant set of groups G_{R} and the important set of groups G_{I} based on the identification of the Ĝₚ redundant groups.

In block 714, the pruning component 116 iteratively performs pruning and knowledge-transferring operations for Tₚ steps for the current pruning period p. t represents a current iteration. As part thereof, in block 716, the pruning component 116 updates the parameters of the groups by performing one iteration of training. This operation is given by \hat{x}ₜ₊₁←xₜ−αₜ∇ƒ(xₜ). In block 718, the pruning component 116 computes a penalty ratio [γₜ]_{G} for each group, which will subsequently be used to project each redundant group towards the origin point. In some implementations, the penalty ratio is expressed as:

$${[ {γ}_{t} ]}_{g} = \frac{{T}_{p} - t - 1}{{T}_{p} - t} \frac{‖ {[ {x}_{t} ]}_{g} ‖}{‖ {[ {\hat{x}}_{t + 1} ]}_{g} ‖} .$$

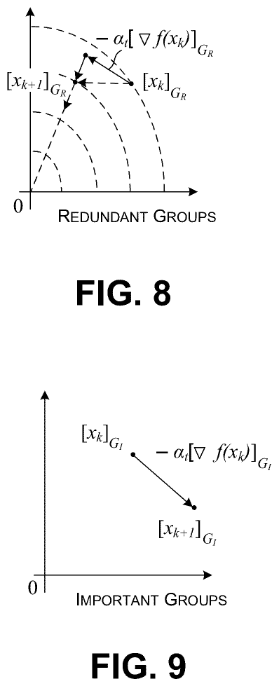

In block 720, the pruning component 116 updates the parameters of the for the redundant groups based on the results of blocks 714 and 716, e.g., as expressed by [xₜ₊₁]G_{R}←[γ_{G}_{_{R}}][\hat{x}ₜ₊₁]_{G}_{_{R}}. Repetition of this operation in plural steps advances the parameters of the redundant groups toward the point of origin, e.g., by successively reducing the sizes of the parameters. FIG. 8 shows an illustrative trajectory of a parameter towards zero over plural iterations. For example, FIG. 8 shows the vector contributions that advance a parameter x from point xₖ to point xₓ₊₁. In block 722, the pruning component 116 updates the parameters of the important groups based on the results of block 714. FIG. 9 shows an example of updating a parameter of an important group, e.g., showing the advancement from point xₖ to point xₖ₊₁.

In block 724 of FIG. 7, after the completion of the pruning stage 604, the pruning component 116 performs post-pruning of the important groups until a specified point of convergence is reached. This operation corresponds to the post-pruning stage 606 shown in FIG. 6.

Overall, the process 702 offers a structured and iterative manner of controlling the pruning operation. This reduces the need for an expert to manually specify complex hyper-parameters. This factor consequently improves the reliability and user-friendliness of the pruning component 116. The process 702 also applies to many different kinds of neural networks without the need for special modification of code, which promotes the scalability of the process 702.

### D. Pruning with Correction of Redundant Groups

FIG. 10 provides an overview of an implementation of a redundancy-checking component 1002. The redundancy-checking component 1002 samples the saliency of the candidate redundant groups at plural points over the course of the projection of these groups toward the origin point (e.g., zero). The redundancy-checking component 1002 leverages this information to make a more accurate assessment of the groups that should be classified as redundant. In one implementation, the pruning component 116 incorporates the use of the redundancy-checking component 1002 as a safeguard to reduce the risk that an important group is erroneously identified as a redundant group. This outcome is desirable because the removal of an important group can degrade the functionality of a neural network, often irreparably.

A data store 1004 specifies a set V of candidate redundant groups being investigated at a current point in the pruning. A data store 1006 specifies a set \hat{V} of groups that have been flagged as redundant but are not currently in V. This group is referred to as the outlier set for brevity. A data store 1008 specifies a set H of candidate redundant groups that have been tested a sufficient number of times, and are thereby considered adequately vetted. This set is referred to below as the historical set. A data store 1010 stores a final set of redundant groups G_{R} that the redundancy-checking component 1002 identifies at the end of its processing based on saliency information collected during pruning.

Functionality 1012 performs iterative processing on the sets of groups described above. A saliency-determining component 1014 provides a saliency score for each group under consideration using one or more of the saliency metrics set forth above in Section C. A data store 1016 stores the saliency scores computed by the saliency-determining component 1014 over one or more iterations of the pruning operation. A set-updating component 1018 updates the membership of various sets of groups described above based on the saliency scores. A parameter-updating component 1020 updates parameters in the groups.

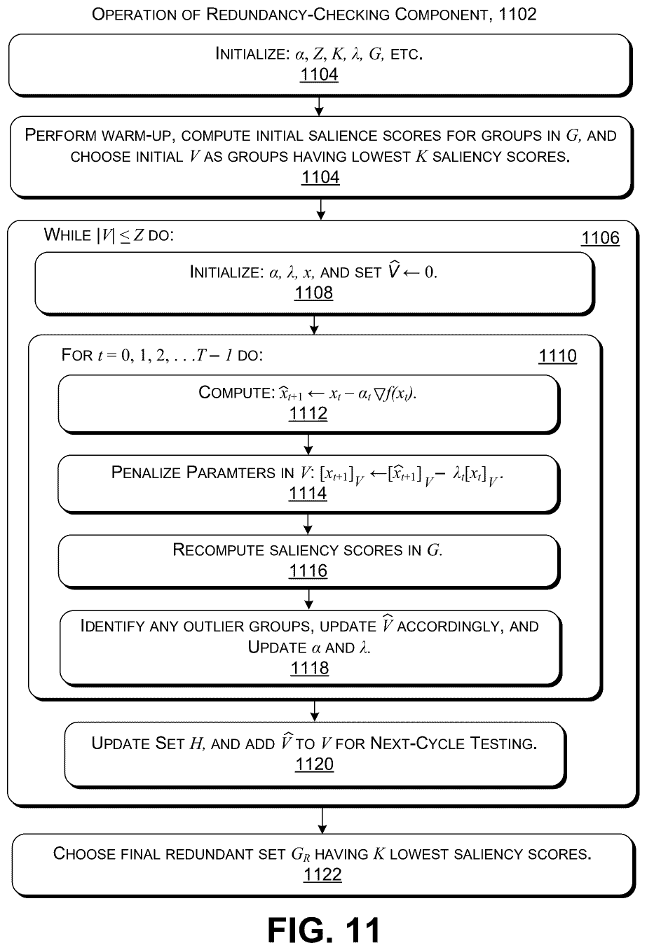

FIG. 11 shows a process 1102 that explains one manner of operation of the redundancy-checking component 1002. In block 1104, the redundancy-checking component 1002 sets up various control parameters, such as a learning rate (α), a termination toleration Z, sample steps (T), a target group sparsity (K), and a penalty (λ). As before, x is a trainable parameter and G is the total number of parameter groups identified by the candidate group-identifying component 114. In block 1104, the redundancy-checking component 1002 optionally performs warm-up training. The redundancy-checking component 1002 then makes an initial assessment of the saliency of the candidate groups and initializes the set V of candidate redundant groups to include those groups having the K lowest saliency scores.

In block 1106, the redundancy-checking component 1002 performs iterative analysis until the number of candidate groups in V exceeds a prescribed number, as given by the termination tolerance (Z). This is expressed by |V|I≤Z. The overall purpose of the block 1106 is to explore the saliency of candidate groups over the course of their projection towards the origin point. In block 1108, the redundancy-checking component 1002 resets the learning rate (α), parameters values x, and the penalty (λ), and sets the outlier group \hat{V} to zero.

In block 1110, the redundancy-checking component 1002 performs a series of operations for T steps, each step being denoted by t. First, in block 1112, the redundancy-checking component 1002 updates the parameters of the groups. This operation is given by \hat{x}ₜ₊₁←xₜ−αₜ∇ƒ(xₜ). In block 1114, the redundancy-checking component 1002 penalizes the parameters in the set V based on: [xₜ₊₁]_{V}←[xₜ₊₁]_{V}−λₜ[xₜ]_{V}. In block 1116, the redundancy-checking component 1002 recomputes the saliency of the groups in G, and stores the results in the data store 1016. S represents the complete set of saliency scores computed thus far. In block 1118, the redundancy-checking component 1002 determines whether the K groups having the lowest saliency scores includes any new members not presently accounted for in the set V. If so, the redundancy-checking component 1002 adds these new groups to the outlier set V. The redundancy-checking component updates the penalty ratio, e.g., using the same or similar equation to that set forth with respect to block 718 of FIG. 7. The learning rate a is also optionally updated to affect the rate of learning for a next step.

In block 1120, after the completion of the iterative processing in block 1110, the redundancy-checking component 1002 updates the historical set H to include the candidate groups in V, if V does not already include these groups. Further, the redundancy-checking component 1002 adds the outlier groups from \hat{V} to V. This sets up the pruning component 116 to analyze these new groups in the next invocation of block 1106.

At the close of the above-described saliency sampling operation, in block 1122, the redundancy-checking component 1002 chooses a final set of redundant groups based on the candidate groups encountered thus far and their respective saliency scores expressed in S. In some implementations, the redundancy-checking component 1002 makes a comprehensive assessment of the saliency of a candidate group over the course of its projection towards the origin point, e.g., by generating a weighted average of the saliency scores taken along this path. In this implementation, the redundancy-checking component 1002 will treat saliency scores captured close to the origin point (e.g., zero)—particularly those scores derived from the Taylor series—as more reliable than those captured farther from the origin point. Accordingly, the redundancy-checking component 1002 will weight the scores captured closer to zero higher than those captured farther from zero. Other implementations may vary the way that saliency scores are exploited, e.g., by only choosing the saliency score captured closest to zero. As explained, such a score tends to be more reliable than a single saliency decision made farther from zero.

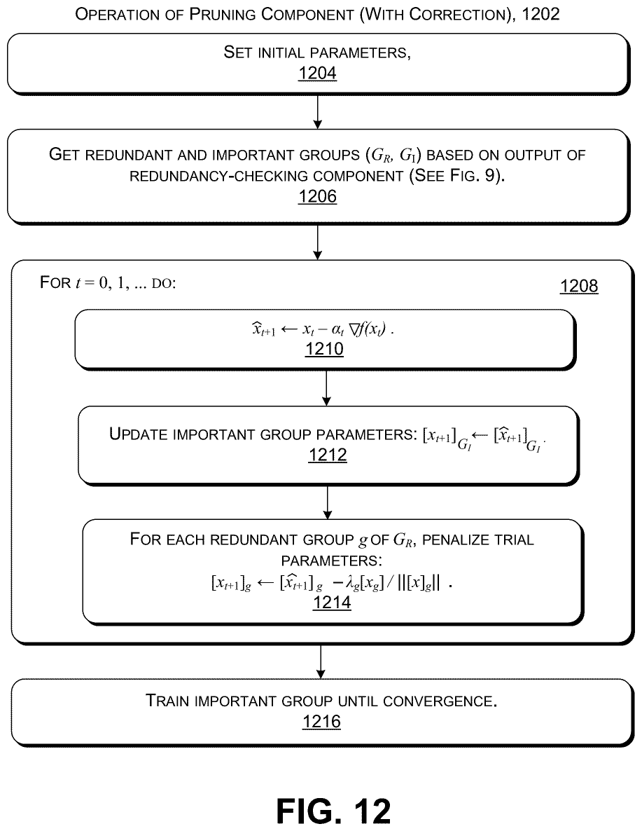

FIG. 12 shows a process 1202 that represents an implementation of the pruning component 116 that incorporates use of the redundancy-checking component 1002. In block 1204, the training component 116 sets up various control parameters, such as the learning rate (α). In block 1206, the training component 116 receives an indication of the final set of redundant groups R_{G} computed by the redundancy-checking component 1002, per the process 1102 of FIG. 11. The pruning component 116 also retrieves information from the process 1102 regarding the computed penalties. Further note that the parameters that are decremented in the process 1102 of FIG. 2 are restored to their original at the outset of process 1202. This is because the process 1102 of FIG. 11 is performed only to provide a reliable estimate of the redundant groups R_{G}.

In block 1208, the pruning component 116 iteratively performs a series of operations, each instance of which is denoted by t. As part thereof, in block 1210, the pruning component 116 updates the parameters of the groups. This operation is given by \hat{x}ₜ₊₁←xₜ−αₜ∇ƒ(xₜ). In block 1212, the pruning component 116 updates the results of the important groups G_{I} based on the results of block 1210 (that is, [xₜ₊₁]_{G}_{_{I}}←[\hat{x}ₜ₊₁]_{G}_{_{I}}). In block 1214, the pruning component 116 penalizes the parameters of each redundant group based on the penalty λ. This operation is given by [xₜ₊₁]_{g}←[\hat{x}ₜ₊₁]_{g}−λ_{g}[x_{g}]/∥[x]_{g}∥.

In operation 1216, the pruning component 116 optionally performs post-pruning training of the important groups until a point of convergence is reached.

### E. Illustrative Performance

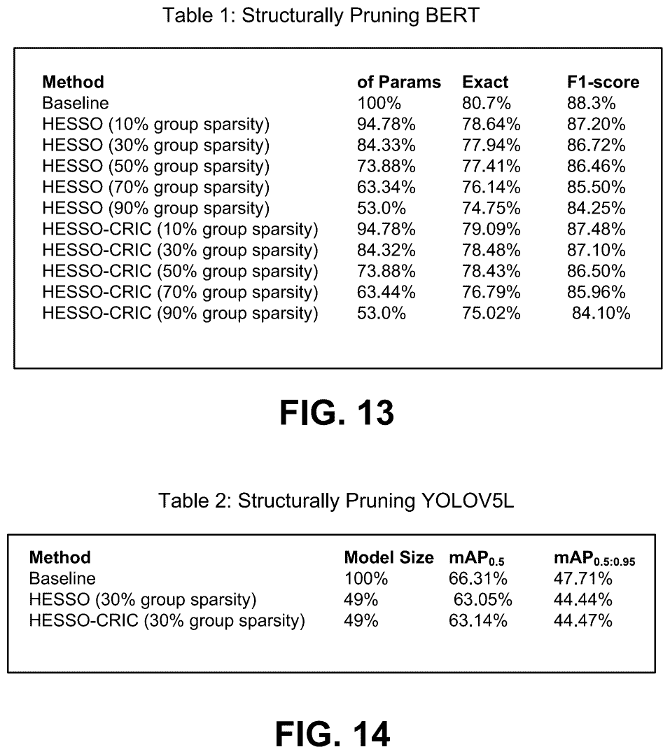

FIG. 13 shows the performance of the computing system 102 of FIG. 1 for the case in which the original neural network is a language model, such as the kind of BERT-based transformer described in Devlin, et al., BERT: Pre-training of Deep Bidirectional Transformers for Language Understanding,” arXiv, arXiv:1810.04805v2 [cs.CL], May 24, 2019, 16 pages. A first column of FIG. 13 describes the characteristics of each trial run. A first entry in this column represents the baseline performance of the language model, without the effects of pruning. Alternatively, this entry provides some other performance results that constitute a baseline reference. Other entries in the first column represent the performance of computing system 102 of FIG. 1 for different sparsity levels K. The acronym HESSO stands for Hybrid Efficient Structured Sparse Optimizer, and is intended to refer to computing system 102 of FIG. 1. HESSO-CRIC represents a version of the pruning system 106 that employs the redundancy-checking component 1002. The second column represents the percentage of parameters retained in each pruning experiment. The third and fourth columns represent different measures of the accuracy of the computing system 102 for the different pruning experiments. “Exact” represents a score computed as a linear combination of plural of the above-described saliency measures, e.g., equally weighted. F1 is a well-known type score that represents the average of precision and recall measures.

As a general observation, the computing system of FIG. 2 is capable of compressing the original language model without significantly degrading its performance. Further note that the inclusion of the redundancy-checking component 102 produces some improvement in performance, relative to the counterpart trial versions that do not use the redundancy-checking component 1002.

FIG. 14 shows the performance of the computing system 102 of FIG. 1, as applied to version v5 of the YOLO object detection model (e.g., as described in Hussain, Muhammad, “YOLOv5, YOLOv8 and YOLOv10: The Go-To Detectors for Real-time Vision,” arXiv, arXiv:2407.02988v1 [cs.CV], Jul. 3, 2024, 12 pages). The first entry of the first column again represents baseline performance results provided by some reference source. A second entry in the first column represents a version of the computing system 102 (HESSO) that does not use the redundancy-checking component 1002, for a sparsity level of 30 percent. A third entry in the first column represents a version of the computing system 102 (HESSO-CRIC) that uses the redundancy-checking component 1002. The second column specifies the model sizes of the different versions. The third and fourth columns specify different mean Average Precision (mAP) measures of performance, which is a well-known type of performance measure. Again note that the computing system 102 compresses the original model without significantly degrading its performance.

### F. Illustrative Flowcharts

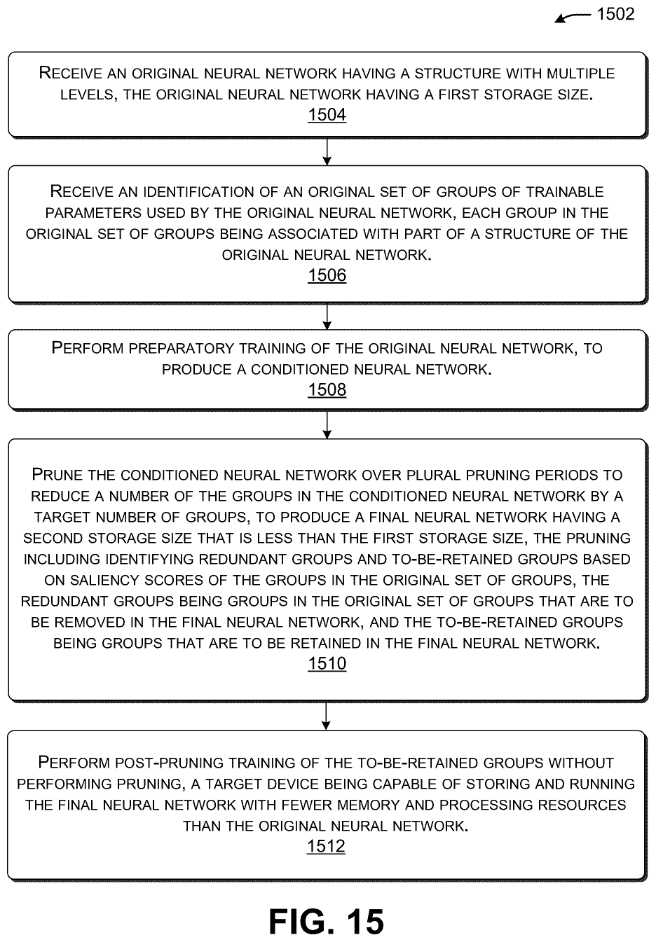

FIGS. 15-17 represent three different aspects of the operation of the computing system 102 of FIG. 1. Each of the processes is expressed as a series of operations performed in a particular order. But the order of these operations is merely representative, and the operations are capable of being varied in other implementations. Further, any two or more operations described below are capable of being performed in a parallel manner. In one implementation, the blocks shown in the processes that pertain to processing-related functions are implemented by the computing equipment described in connection with FIGS. 18 and 19.

More specifically, FIG. 15 shows a first process 1502 that describes the operation of the computing system 102. In block 1504, the computing system 102 receives an original neural network having a structure with multiple levels, the original neural network having a first storage size. In block 1506, the computing system 102 receives an identification of an original set of groups of trainable parameters used by the original neural network, each group in the original set of groups being associated with part of a structure of the original neural network. In block 1508, the computing system 102 performs preparatory training of the original neural network, to produce a conditioned neural network. In block 1510, the computing system 102 performs pruning of the conditioned neural network over plural pruning periods to reduce a number of the groups in the conditioned neural network by a target number (K) of groups, to produce a final neural network having a second storage size that is less than the first storage size. The pruning includes identifying redundant groups and to-be-retained groups based on saliency scores of the groups in the original set of groups. The redundant groups are groups in the original set of groups that are to be removed in the final neural network, and the to-be-retained groups are groups that are to be retained in the final neural network. In block 1512, the computing system 102 performs post-pruning training of the to-be-retained groups without performing pruning. A target device is capable of storing and running the final neural network with fewer memory and processing resources than the original neural network.

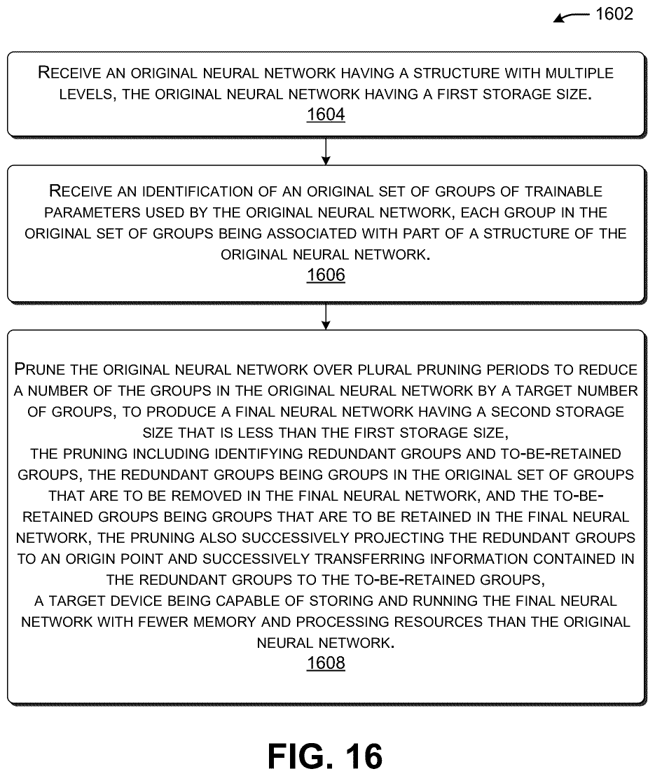

FIG. 16 shows a second process 1602 that describes another aspect of the operation of the computing system 102. In block 1604, the computing system 102 receives an original neural network having a structure with multiple levels, the original neural network having a first storage size. In block 1606, the computing system 102 receives an identification of an original set of groups of trainable parameters used by the original neural network, each group in the original set of groups being associated with part of a structure of the original neural network. In block 1608, the computing system 102 performs pruning of the original neural network over plural pruning periods to reduce a number of the groups in the original neural network by a target number of groups, to produce a final neural network having a second storage size that is less than the first storage size. The pruning includes identifying redundant groups and to-be-retained groups, the redundant groups being groups in the original set of groups that are to be removed in the final neural network, and the to-be-retained groups being groups that are to be retained in the final neural network. The pruning also successively projects the redundant groups to an origin point and successively transfers information contained in the redundant groups to the to-be-retained groups. A target device is capable of storing and running the final neural network with fewer memory and processing resources than the original neural network.

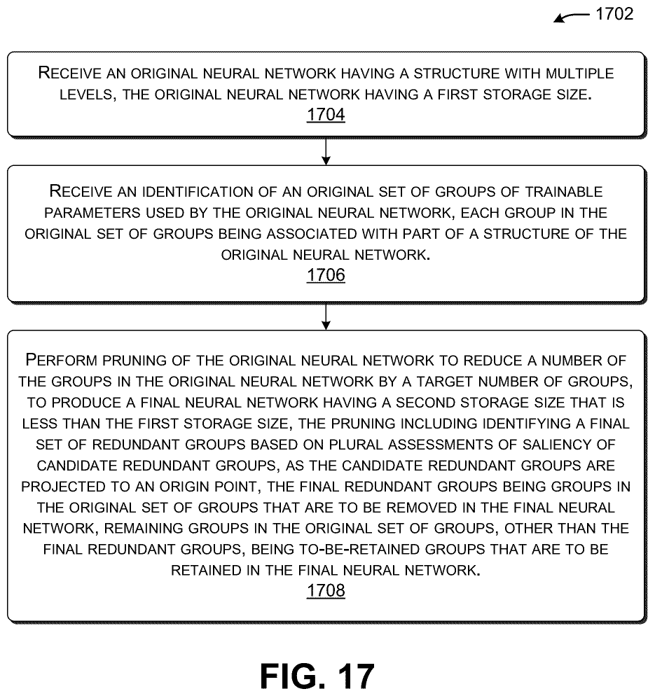

FIG. 17 shows a third process 1702 that describes another aspect of the operation of the computing system 102. In block 1704, the computing system 102 receives an original neural network having a structure with multiple levels, the original neural network having a first storage size. In block 1706, the computing system 102 receives an identification of an original set of groups of trainable parameters used by the original neural network, each group in the original set of groups being associated with part of a structure of the original neural network. In block 1708, the computing system 102 performs pruning of the original neural network to reduce a number of the groups in the original neural network by a target number of groups, to produce a final neural network having a second storage size that is less than the first storage size. The pruning includes identifying a final set of redundant groups based on plural assessments of saliency of candidate redundant groups, as the candidate redundant groups are projected to an origin point. The final redundant groups are groups in the original set of groups that are to be removed in the final neural network. Remaining groups in the original set of groups, other than the final redundant groups, are to-be-retained groups that are to be retained in the final neural network.

### G. Illustrative Computing Functionality

FIG. 18 shows computing equipment 1802 that, in some implementations, is used to implement the computing system 102. The computing equipment 1802 includes a set of local devices 1804 coupled to a set of servers 1806 via a computer network 1808. Each local device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, a vehicle-borne computing system, any type of robot computing system, a computing system in a manufacturing system, etc. In some implementations, the computer network 1808 is implemented as a local area network, a wide area network (e.g., the Internet), one or more point-to-point links, or any combination thereof.

The bottom-most overlapping box in FIG. 18 indicates that the functionality of the computing system 102 is capable of being spread across the local devices 1804 and/or the servers 1806 in any manner. In one example, the computing system 102 is entirely implemented by a local device. In another example, the functions of the computing system 102 are entirely implemented by the servers 1806. Here, a user is able to interact with the servers 1806 via a browser application running on a local device. In other examples, some of the functions of the computing system 102 are implemented by a local device, and other functions of the computing system 102 are implemented by the servers 1806.

Likewise, the pruned model itself is capable of being stored and executed on any local device, any network-accessible system device(s), or any combination thereof.

FIG. 19 shows a computing system 1902 that, in some implementations, is used to implement any aspect of the mechanisms set forth in the above-described figures. For instance, in some implementations, the type of computing system 1902 shown in FIG. 19 is used to implement any local computing device or any server shown in FIG. 18. In all cases, the computing system 1902 represents a physical and tangible processing mechanism.

The computing system 1902 includes a processing system 1904 including one or more processors. The processor(s) include one or more central processing units (CPUs), and/or one or more graphics processing units (GPUs), and/or one or more application specific integrated circuits (ASICs), and/or one or more neural processing units (NPUs), and/or one or more tensor processing units (TPUs), etc. More generally, any processor corresponds to a general-purpose processing unit or an application-specific processor unit.

The computing system 1902 also includes computer-readable storage media 1906, corresponding to one or more computer-readable media hardware units. The computer-readable storage media 1906 retains any kind of information 1908, such as machine-readable instructions, settings, model weights, and/or other data. In some implementations, the computer-readable storage media 1906 includes one or more solid-state devices, one or more hard disks, one or more optical disks, etc. Any instance of the computer-readable storage media 1906 represents a fixed or removable unit of the computing system 1902. Further, any instance of the computer-readable storage media 1906 provides volatile and/or non-volatile retention of information. The specific term “computer-readable storage medium” or “storage device” expressly excludes propagated signals per se in transit; a computer-readable storage medium or storage device is “non-transitory” in this regard.

The computing system 1902 utilizes any instance of the computer-readable storage media 1906 in different ways. For example, in some implementations, any instance of the computer-readable storage media 1906 represents a hardware memory unit (such as random access memory (RAM)) for storing information during execution of a program by the computing system 1902, and/or a hardware storage unit (such as a hard disk) for retaining/archiving information on a more permanent basis. In the latter case, the computing system 1902 also includes one or more drive mechanisms 1910 (such as a hard drive mechanism) for storing and retrieving information from an instance of the computer-readable storage media 1906.

In some implementations, the computing system 1902 performs any of the functions described above when the processing system 1904 executes computer-readable instructions stored in any instance of the computer-readable storage media 1906. For instance, in some implementations, the computing system 1902 carries out computer-readable instructions to perform each block of the processes described with reference to FIGS. 15-17. FIG. 19 generally indicates that hardware logic circuitry 1912 includes any combination of the processing system 1904 and the computer-readable storage media 1906.

In addition, or alternatively, the processing system 1904 includes one or more other configurable logic units that perform operations using a collection of logic gates, such as field-programmable gate arrays (FPGAs), etc. In these implementations, the processing system 1904 effectively incorporates a storage device that stores computer-readable instructions, insofar as the configurable logic units are configured to execute the instructions and therefore embody or store these instructions.

In some cases (e.g., in the case in which the computing system 1902 represents a user computing device), the computing system 1902 also includes an input/output interface 1914 for receiving various inputs (via input devices 1916), and for providing various outputs (via output devices 1918). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1920 and an associated graphical user interface presentation (GUI) 1922. The display device 1920 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1902 also includes one or more network interfaces 1924 for exchanging data with other devices via one or more communication conduits 1926. One or more communication buses 1928 communicatively couple the above-described units together.

The communication conduit(s) 1926 is implemented in any manner, e.g., by a local area computer network, a wide area computer network (e.g., the Internet), point-to-point connections, or any combination thereof. The communication conduit(s) 1926 include any combination of hardwired links, wireless links, routers, gateway functionality, name servers, etc., governed by any protocol or combination of protocols.

FIG. 19 shows the computing system 1902 as being composed of a discrete collection of separate units. In some cases, the collection of units corresponds to discrete hardware units provided in a computing device chassis having any form factor. FIG. 19 shows illustrative form factors in its bottom portion. In other cases, the computing system 1902 includes a hardware logic unit that integrates the functions of two or more of the units shown in FIG. 19. For instance, in some implementations, the computing system 1902 includes a system on a chip (SoC or SOC), corresponding to an integrated circuit that combines the functions of two or more of the units shown in FIG. 19.

The following summary provides a set of illustrative examples of the technology set forth herein.

(A1) According to one aspect, a method (e.g., the process 1602) for pruning a neural network is described. The method includes: receiving (e.g., in block 1604) an original neural network (e.g., the original neural network 104) having a structure with multiple levels, the original neural network having a first storage size; receiving (e.g., in block 1606) an identification of an original set of groups of trainable parameters used by the original neural network, each group in the original set of groups being associated with part of a structure of the original neural network; and pruning (e.g., in block 1608) the original neural network over plural pruning periods to reduce a number of the groups in the original neural network by a target number of groups, to produce a final neural network (e.g., the final neural network 108) having a second storage size that is less than the first storage size. The pruning includes identifying redundant groups and to-be-retained groups, the redundant groups being groups in the original set of groups that are to be removed in the final neural network, and the to-be-retained groups being groups that are to be retained in the final neural network. The pruning also successively projects the redundant groups to an origin point and successively transferring information contained in the redundant groups to the to-be-retained groups. A target device (e.g., any of the devices 112) is capable of storing and running the final neural network with fewer memory and processing resources than the original neural network. The method is efficient and well-controlled and produces increased levels of compression compared to other techniques. The method is also scalable and user-friendly, which reduces the need for ad hoc configuration efforts by an expert.

(A2) According to some aspects of the method of A1, each group in the original set of groups is associated with a group of one or more components in the original neural network, the group of one or more components having been determined to produce zero outputs upon setting trainable parameters in the group of one or more components to zero.

(A3) According to some aspects of the methods of A1 or A2, the pruning is preceded by preparatory training in which the original neural network is trained without pruning.

(A4) According to some aspects of any of the methods of A1-A3, the pruning is followed by post-pruning training in which the to-be-retained groups are trained without performing pruning.

(A5) According to some aspects of any of the methods of A1-A4, the pruning includes determining that a particular group is a redundant group based on a saliency score associated with the particular group, the saliency score measuring an impact of the particular group on functions performed by the original neural network.

(A6) According to some aspects of the method of A5, the saliency score depends on two more metrics that measure an impact of the particular group on functions performed by the original neural network.

(A7) According to some aspects of any of the methods of A1-A6, in each pruning period, the pruning determines a subset of redundant groups, the subset of redundant groups being a subset of the target number of groups.

(A8) According to some aspects of any of the methods of A1-A7, for a particular redundant group and for a particular pruning period, the successively projecting includes: diminishing a contribution of the particular redundant group by applying a penalty ratio to the particular redundant group, the diminishing being preceded by updating trainable parameters of the particular redundant group.

(A9) According to some aspects of any of the methods of A1-A8, the successively transferring of the information to the to-be-retained groups includes successively updating trainable parameters of the to-be-retained groups.

(A10) According to some aspects of any of the methods of A1-A9, the pruning identifies a final set of redundant groups based on plural assessments of saliency of candidate redundant groups, as the candidate redundant groups are projected to the origin point.

(A11) According to some aspects of any of the methods of A1-A10, the pruning identifies a final set of redundant groups by: successively updating trainable parameters in the original set of groups; successively determining saliency scores of the groups in the original set of groups; successively identifying candidate redundant groups based on the saliency scores; successively projecting the candidate redundant groups towards the origin point; and determining the final set of redundant groups based on an assessment of the candidate redundant groups that have been identified, and saliency scores associated therewith as the candidate redundant groups are projected towards the origin point.

(A12) According to some aspects of any of the method of A11, the method further includes: determining a first saliency score for a particular candidate redundant group that is a first distance from the origin point; determining a second saliency score for the particular candidate redundant group when the particular candidate redundant group is a second distance from the origin point that is less than the first distance; and associating greater weight to the second saliency score compared to the first saliency score in determining whether the particular redundant group is a final redundant group.

(A13) According to some aspects of any of the methods of A1-A12, the method further includes storing the final neural network in a storage device of the target device.

(B1) According to another aspect, another method (e.g., the process 1502) is described for pruning a neural network. The method includes: receiving (e.g., in block 1504) an original neural network (e.g., the original neural network 104) having a structure with multiple levels, the original neural network having a first storage size; receiving (e.g., in block 1506) an identification of an original set of groups of trainable parameters used by the original neural network, each group in the original set of groups being associated with part of a structure of the original neural network; performing (e.g., in block 1508) preparatory training of the original neural network, to produce a conditioned neural network; and pruning (e.g., in block 1510) the conditioned neural network over plural pruning periods to reduce a number of the groups in the conditioned neural network by a target number of groups, to produce a final neural network (e.g., the final neural network 108) having a second storage size that is less than the first storage size. The pruning includes identifying redundant groups and to-be-retained groups based on saliency scores of the groups in the original set of groups, the redundant groups being groups in the original set of groups that are to be removed in the final neural network, and the to-be-retained groups being groups that are to be retained in the final neural network. The method further includes performing (e.g., in block 1512) post-pruning training of the to-be-retained groups without performing pruning. A target device is capable of storing and running the final neural network with fewer memory and processing resources than the original neural network. The method has the same technical benefits as A1.

(C1) According to another aspect, another method (e.g., the process 1702) is described for pruning a neural network. The method includes: receiving (e.g., in block 1704) an original neural network (e.g., the original neural network 104) having a structure with multiple levels, the original neural network having a first storage size; receiving (e.g., in block 1706) an identification of an original set of groups of trainable parameters used by the original neural network, each group in the original set of groups being associated with part of a structure of the original neural network; and pruning (e.g., in block 1708) the original neural network to reduce a number of the groups in the original neural network by a target number of groups, to produce a final neural network (e.g., the final neural network 108) having a second storage size that is less than the first storage size. The pruning includes identifying a final set of redundant groups based on plural assessments of saliency of candidate redundant groups, as the candidate redundant groups are projected to an origin point. The final redundant groups are groups in the original set of groups that are to be removed in the final neural network. The groups in the original set of groups, other than the final redundant groups, are to-be-retained groups that are to be retained in the final neural network. The method offers the same technical benefits as A1, with the added benefit of reducing the risk that a to-be-retained group is erroneously classified as a redundant group and is subsequently removed from the original neural network.

In yet another aspect, some implementations of the technology described herein include a computing system (e.g., the computing system 1902) that includes a processing system (e.g., the processing system 1904) having a processor. The computing system also includes a storage device (e.g., the computer-readable storage media 1906) for storing computer-readable instructions (e.g., the information 1908). The processing system executes the computer-readable instructions to perform any of the methods described herein (e.g., any individual method of the methods of A1-A12, B1, and Cl).

In yet another aspect, some implementations of the technology described herein include a computer-readable storage medium (e.g., the computer-readable storage media 1906) for storing computer-readable instructions (e.g., the information 1908). A processing system (e.g., the processing system 1904) executes the computer-readable instructions to perform any of the operations described herein (e.g., the operations in any individual method of the methods of A1-A12, B1, and C1).

More generally stated, any of the individual elements and steps described herein are combinable into any logically consistent permutation or subset. Further, any such combination is capable of being manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

This description may have identified one or more features as optional. This type of statement is not to be interpreted as an exhaustive indication of features that are to be considered optional; generally, any feature is to be considered as an example, although not explicitly identified in the text, unless otherwise noted. Further, any features described as alternative ways of carrying out identified functions or implementing identified mechanisms are also combinable together in any combination, unless otherwise noted.

In terms of specific terminology, the phrase “configured to” encompasses various physical and tangible mechanisms for performing an identified operation. The mechanisms are configurable to perform an operation using the hardware logic circuitry 1912 of FIG. 19. The term “logic” likewise encompasses various physical and tangible mechanisms for performing a task. For instance, each processing-related operation illustrated in the flowcharts of FIGS. 15-17 corresponds to a logic component for performing that operation.

Further, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” is a group that includes one or more members. The phrase “A corresponds to B” means “A is B” in some contexts. The term “prescribed” is used to designate that something is purposely chosen according to any environment-specific considerations. For instance, a threshold value or state is said to be prescribed insofar as it is purposely chosen to achieve a desired result. “Environment-specific” means that a state is chosen for use in a particular environment. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for pruning a neural network, comprising:
receiving an original neural network having a structure with multiple levels, the original neural network having a first storage size;
receiving an identification of an original set of groups of trainable parameters used by the original neural network, each group in the original set of groups being associated with part of a structure of the original neural network; and
pruning the original neural network over plural pruning periods to reduce a number of the groups in the original neural network by a target number of groups, to produce a final neural network having a second storage size that is less than the first storage size,
the pruning including identifying redundant groups and to-be-retained groups, the redundant groups being groups in the original set of groups that are to be removed in the final neural network, and the to-be-retained groups being groups that are to be retained in the final neural network,
the pruning also successively projecting the redundant groups to an origin point and successively transferring information contained in the redundant groups to the to-be-retained groups,
a target device being capable of storing and running the final neural network with fewer memory and processing resources than the original neural network.

2. The method of claim 1, wherein each group in the original set of groups is associated with a group of one or more components in the original neural network, the group of one or more components having been determined to produce zero outputs upon setting trainable parameters in the group of one or more components to zero.

3. The method of claim 1, wherein the pruning is preceded by preparatory training in which the original neural network is trained without pruning.

4. The method of claim 1, wherein the pruning is followed by post-pruning training in which the to-be-retained groups are trained without performing pruning.

5. The method of claim 1, wherein the pruning includes determining that a particular group is a redundant group based on a saliency score associated with the particular group, the saliency score measuring an impact of the particular group on functions performed by the original neural network.

6. The method of claim 5, wherein the saliency score depends on two more metrics that measure an impact of the particular group on functions performed by the original neural network.

7. The method of claim 1, wherein, in each pruning period, the pruning determines a subset of redundant groups, the subset of redundant groups being a subset of the target number of groups.

8. The method of claim 1, wherein, for a particular redundant group and for a particular pruning period, the successively projecting includes:
diminishing a contribution of the particular redundant group by applying a penalty ratio to the particular redundant group,
the diminishing being preceded by updating trainable parameters of the particular redundant group.

9. The method of claim 1, wherein the successively transferring of the information to the to-be-retained groups includes successively updating trainable parameters of the to-be-retained groups.

10. The method of claim 1, wherein the pruning identifies a final set of redundant groups based on plural assessments of saliency of candidate redundant groups, as the candidate redundant groups are projected to the origin point.

11. The method of claim 1, wherein the pruning identifies a final set of redundant groups by:
successively updating trainable parameters in the original set of groups;
successively determining saliency scores of the groups in the original set of groups;
successively identifying candidate redundant groups based on the saliency scores;
successively projecting the candidate redundant groups towards the origin point; and
determining the final set of redundant groups based on an assessment of the candidate redundant groups that have been identified, and saliency scores associated therewith as the candidate redundant groups are projected towards the origin point.

12. The method of claim 11, further comprising:
determining a first saliency score for a particular candidate redundant group that is a first distance from the origin point;
determining a second saliency score for the particular candidate redundant group when the particular candidate redundant group is a second distance from the origin point that is less than the first distance; and
associating greater weight to the second saliency score compared to the first saliency score in determining whether the particular redundant group is a final redundant group.

13. The method of claim 1, further comprising storing the final neural network in a storage device of the target device.

14. A computing system for pruning a neural network, comprising:
an instruction data store for storing computer-readable instructions; and
a processing system for executing the computer-readable instructions in the data store, to perform operations including:
receiving an original neural network having a structure with multiple levels, the original neural network having a first storage size;
receiving an identification of an original set of groups of trainable parameters used by the original neural network, each group in the original set of groups being associated with part of a structure of the original neural network;
performing preparatory training of the original neural network, to produce a conditioned neural network;
pruning the conditioned neural network over plural pruning periods to reduce a number of the groups in the conditioned neural network by a target number of groups, to produce a final neural network having a second storage size that is less than the first storage size,
the pruning including identifying redundant groups and to-be-retained groups based on saliency scores of the groups in the original set of groups, the redundant groups being groups in the original set of groups that are to be removed in the final neural network, and the to-be-retained groups being groups that are to be retained in the final neural network; and
performing post-pruning training of the to-be-retained groups without performing pruning,
a target device being capable of storing and running the final neural network with fewer memory and processing resources than the original neural network.

15. The computing system of claim 14, wherein the pruning includes, over plural pruning periods:
successively projecting the redundant groups to an origin point; and
successively transferring information contained in the redundant groups to the to-be-retained groups.

16. The computing system of claim 15, wherein, for a particular redundant group and for a particular pruning period, the successively projecting includes:
diminishing a contribution of the particular redundant group by applying a penalty ratio to the particular redundant group,
the diminishing being preceded by updating trainable parameters of the particular redundant group.

17. The computing system of claim 15, wherein the successively transferring of the information to the to-be-retained groups includes successively updating trainable parameters of the to-be-retained groups.

18. The computing system of claim 14, wherein the pruning identifies a final set of redundant groups based on plural assessments of saliency of candidate redundant groups, as the candidate redundant groups are projected to the origin point.

19. A computer-readable storage medium for storing computer-readable instructions, a processing system executing the computer-readable instructions to perform operations, the operations comprising each of:
receiving an original neural network having a structure with multiple levels, the original neural network having a first storage size;
receiving an identification of an original set of groups of trainable parameters used by the original neural network, each group in the original set of groups being associated with part of a structure of the original neural network; and
pruning the original neural network to reduce a number of the groups in the original neural network by a target number of groups, to produce a final neural network having a second storage size that is less than the first storage size,
the pruning including identifying a final set of redundant groups based on plural assessments of saliency of candidate redundant groups, as the candidate redundant groups are projected to an origin point,
the final redundant groups being groups in the original set of groups that are to be removed in the final neural network,
remaining groups in the original set of groups, other than the final redundant groups, being to-be-retained groups that are to be retained in the final neural network.

20. The computer-readable storage medium of claim 19, wherein the pruning is performed in plural periods, each period including:
projecting each of the final redundant groups to the origin point; and
transferring information contained in each of the final redundant groups to the to-be-retained groups by training the to-be-retained groups.
